(19) United States
(12) Patent Application Publication
(10) Pub. No.: US 2018/0291243 A1
(43) Pub. Date: Oct. 11, 2018

(54) A CARD PROTECTIVE FILM, A PRODUCTION METHOD AND A PAYMENT CARD

(71) Applicant: TIANJIN BOYUAN NEW MATERIALS CO., LTD, Tianjin (CN)

(72) Inventor: Tianzhi Yang, Guangdong (CN)

(21) Appl. No.: 15/572,280

(22) PCT Filed: Aug. 8, 2017
(86) PCT No.: PCT/CN2017/096448

§ 371 Date: Nov. 7, 2017

(30) Foreign Application Priority Data
Aug. 8, 2016 (CN) 201610642164.3

(51) Int. Cl. C09J 175/04; C09J 7/25; G06K 19/077; B32B 37/15; B32B 38/00; B32B 27/08; B32B 27/36

(52) U.S. Cl. CPC C09J 175/04; C09J 7/255; G06K 19/07722; B32B 37/153; B32B 2425/00; B32B 27/08; B32B 27/36; C09J 2431/00; C09J 2467/006; B32B 38/145

(57) ABSTRACT

The present disclosure relates to a card protective film, a production method thereof and a payment card, wherein the card protective film comprises a core layer of a biaxially oriented polyester film, a first connection layer and a printed bonding layer connected to a printed layer of a card substrate, as well as a surface processing layer with function(s) of thermal laminating release, thermal jointing and/or hot stamping; the printed bonding layer is connected to one side of the core layer through the first connection layer, and the surface processing layer is connected to the other side of the core layer. The card protective film can meet the technical performance requirements of the surface tension required by the surface processing of the payment card and also can meet the technical performance requirements of the release and the processing temperature required by the surface processing when the card is being laminated, and can provide better protection for the payment card or other cards, and the payment card or other cards made therefrom have higher transparency, higher surface and overall strength, higher temperature resistant grade, and thus have longer service life.

### TECHNICAL FIELD

The present disclosure relates to a multi-layer product, in particular to a multi-layer product practically composed of a synthetic resin, and especially to a protective film for use when producing a card, as well as a payment card made of the protective film.

### BACKGROUND ART

It is needed to stick a protective film during the production of many cards including a payment card, an identification card, a driver's license card, a transportation card, a parking card, a campus card, a VIP card, a membership card and a time card, and the like, wherein the payment card further includes a card with payment function such as a deposit card and a credit card, and the like. With the rapid development of electronic payment technology and its application, the payment card has become a very prevalent payment tool. At the same time, for transition of a payment card to a chip card globally, the validity duration of a payment card generally extends from two or three years to five years or even longer as well, which requires the payment card to have higher strength and longer service life. The technological form of a payment card has evolved from the original plastic card and magnetic card to a combination of many complex technologies and functions; and the specific technological form of a payment card includes a plastic card, a composite card made of plastic and metal, a magnetic stripe card, a contact IC card (with magnetic stripe or without magnetic stripe), a contactless IC card (with magnetic stripe or without magnetic stripe) and dual-interface IC card (including contact and contactless interface, with magnetic stripe or without magnetic stripe); the shape and thickness specifications of a payment card are either compliant with the ISO7810 international standard or not. IC is the abbreviation of the English phrase “integrate circuit”.

Due to the financial asset attributes of a payment card, the clients generally have high requirements for surface appearance and service life of the payment card, which requires the materials of a payment card to have good surface processing properties, meanwhile a high strength and service life. A thermal laminating process is generally employed during the production of a payment card, which requires that the surface material of the payment card has good thermal laminating release performance to ensure the surface appearance quality of the payment card. At the same time, before the production of the card substrate of the payment card, a magnetic stripe is needed to be jointed to the outer layer, which requires the material of the outer layer of the payment card to have a better jointing property. Moreover, the outer surface of the payment card is needed to be printed with the cardholder's information. The processing of most cardholder's information is performed by way of hot stamping and thermal jointing, which also requires the material of the outer layer of the payment card to have well re-processing and thermal jointing processing properties. However, the release property for surface lamination and the thermal jointing and thermal processing properties for surface processing is relatively contradictory, so that the selection for a material for producing a payment card is restricted to a large extent.

Polyvinyl chloride (PVC) material has good thermal jointing processing and laminating properties, and is economic and easy to obtain. Polyvinyl chloride (PVC) material has been widely used in the field of payment cards since it was used on the magnetic cards invented by IBM in 1960s. The structure of a traditional polyvinyl chloride (PVC) payment card includes a polyvinyl chloride protective film (or a surface layer) and a polyvinyl chloride printed layer (or a core layer), which has advantages of convenience and easy-to-use, however the technical defects of the payment card made of polyvinyl chloride material are also very obvious, the main defects include: (1) the polyvinyl chloride protective film has low strength which is not sufficient to protect the core layer (or the printed layer) of the payment card, and is easy to be broken and peeled off in the use cycle, even fracture of the whole card may occur, leading to poor user experience; (2) the polyvinyl chloride material has low strength and low temperature resistant grade, thus it is easy to embrittle under low temperature environment, leading to the fracture of the card; and it is easy to soften under high temperature environment, so that leading to deformation, and thus making the card unusable; (3) the polyvinyl chloride material has low strength, thus payment card made of the polyvinyl chloride material has low anti-bending and anti-twist abilities, and insufficient protection against external impact force, resulting in easy deformation of the card, so that the chip encapsulated on the surface or inside the card may be impacted, and then leading to short-term or long-term failure of the function of the chip, making the payment card unusable.

Chinese patent CN 102844169 (corresponding to European Patent EP 2374602A) discloses a biaxially oriented polyester (PET) protective film with three-layer structure for protection of security laminates and documents. The three-layer structure of the biaxially oriented polyester (PET) protective film disclosed in this patent comprises an outer layer which adopts a biaxially oriented polyethylene terephthalate (PET-C) film; an intermediate layer which adopts a connection material as the first coating; and a second coating which is composed of polyvinyl chloride/vinyl acetate copolymer. There exists following obvious technical defects in the production process of the card in this patent:

The Chinese Patent for invention with Application No. 201180018065.3 and Application Publication No. CN 102844169A, entitled “PET-C based security laminates and documents” discloses a security laminate with a three-layer structure (i.e., a protective film of the present disclosure) for protection of security documents (i.e., a card of the present disclosure). Referring to FIG. 7, layer 2 of a first coating composition and layer 3 of a second coating composition are provided on one or two sides of layer 1. The material of the layer 1 is a biaxially oriented polyethylene terephthalate (PET-C). The first coating composition comprises a copolymer selected from the group consisting of a hydroxy-functional, partially-hydrolyzed vinyl chloride/vinyl acetate copolymer and a polyester-carbamate copolymer, the second coating composition comprises a hydroxy-functional, partially-hydrolyzed vinyl chloride/vinyl acetate copolymer, and the layer 3 of the second coating composition is used to connect with the security document core 4, and the technical defects thereof are as follows:
I. The security laminates actually cannot be used on the card with a surface requiring special processing such as a payment card, etc., at all, and can only be used on the card with a surface that does not require special processing such as a membership card and a time card, etc. As the security document is formed by adhering the security laminate to the security document core 4, the outer layer of the security document, i.e., the layer 1 of the security laminate, is a biaxially oriented polyethylene terephthalate (PET-C) formed by biaxially stretching polyethylene terephthalate substrate, the layer 1 has a very high surface finish degree with a surface tension of less than 32 dyne (Dyn). However, the thermal jointing technical characteristic needed by the production process of the payment card requires the surface tension of the payment card to be 36 dyne (Dyn) or more. Therefore, the layer 1 of the security laminate of the Patent for invention is far from meeting the surface tension requirement required by the surface processing of the payment card, and it is impossible to carry out the processing needed by the surface such as magnetic stripe jointing, holographic mark hot stamping and/or signature bar hot stamping, etc., but also the processing needed by the surface for information personalization of the payment card such as relief/gravure printing, hot coloring, thermal transfer, photo printing, barcode and two-dimensional code processing and/or laser engraving, and the like.
II. The production process of a traditional card adopts the thermal lamination process to laminate the multi-layer materials and the protective film of the card and uses a steel plate with a certain texture or structure to stamp out a mirror or a semi-gloss (or referred to as matte) effect with microgrooves in a certain direction on the surface of the card to provide an aesthetic effect for the surface of the card, meanwhile preventing the card from scratching during use; the outer layer of the security document formed by adhering the security laminate to the security document core 4 of the Patent for invention is a biaxially oriented polyethylene terephthalate (PET-C) film, the softening temperature of the material of the outer layer 1 is higher than 120° C.; while the softening temperature of the polyvinyl chloride material generally used for the printed layer of a traditional card is lower than 80° C.; If the processing temperature of the outer layer 1 is employed to laminate in order to achieve the surface characteristics, the printed layer will be completely broken; whereas if the processing temperature of the polyvinyl chloride printed layer is employed, the outer layer 1 thereof has not yet reached the processing temperature, thereby failing to provide the surface effects required by the traditional card.

In view of the above, the Chinese Patent for invention with Application No. 201180018065.3 cannot provide the technical performance required by the production process of a card with a surface requiring special processing and the surface information personalization process of a card, i.e., it cannot be practically applied in the production of a card with a surface requiring special processing.

### SUMMARY

The technical problem to be solved by the present disclosure is to provide a card protective film, a production method and a payment card so as to avoid the above-mentioned deficiencies in the related technics. The card protective film can meet the technical performance requirements of the surface tension required by the surface processing of the payment card and also meet the technical performance requirements of the release and the processing temperature required by the surface processing when the card is laminated, and can provide better protection for the payment card or other cards, and the payment card or other cards made therefrom have higher transparency, higher surface and overall strength, higher temperature resistant grade, and thus have longer service life.

The technical solution adopted by the present disclosure for solving the described technical problems is:
providing a card protective film which comprises a core layer of a biaxially oriented polyester film, a first connection layer and a printed bonding layer connected to the printed layer of the card substrate, as well as a surface processing layer with function(s) of thermal laminating release, thermal jointing and/or hot stamping; the printed bonding layer is connected to one side of the core layer through the first connection layer, and the surface processing layer is connected to the other side of the core layer.

The material of the surface processing layer is a thermoplastic resin which includes a vinyl chloride-vinyl acetate copolymer (VC/VAC), a modified vinyl chloride-vinyl acetate copolymer (VC/VAC) or an acrylic acid-modified vinyl chloride-vinyl acetate copolymer (VC/VAC), wherein the modified vinyl chloride-vinyl acetate copolymer (VC/VAC) comprises ethylene, vinyl acetate and acrylic acid monomer, and the acrylic acid-modified vinyl chloride-vinyl acetate copolymer (VC/VAC) comprises a vinyl chloride-vinyl acetate copolymer (VC/VAC) and an acrylic resin.

The percentages by weight of the ethylene, vinyl acetate and acrylic monomer are: ethylene of 79%-90%, vinyl acetate of 9%-16%, and acrylic acid monomer of 1%-5%; and the percentages by weight of the vinyl chloride-vinyl acetate copolymer (VC/VAC) and the acrylic resin are: the vinyl chloride-vinyl acetate copolymer (VC/VAC) of 95%-99%, and the acrylic resin of 1%-5%.

In order to make the connection of the surface processing layer more secure, the card protective film further comprises a second connection layer between the core layer and the surface processing layer so that the surface processing layer is connected to the other side of the core layer through the second connection layer.

The material of each of the first connection layer and the second connection layer is a thermoplastic polyester resin; and the material of the printed bonding layer is a polyurethane.

In the above layers, the thickness of the core layer is the largest, and the thickness of the surface processing layer is the smallest.

The card protective film has a thickness of 20.0 microns to 60.0 microns.

A method for producing a card protective film, comprising the following steps:
step A, preparing a polyethylene terephthalate as the raw material of the core layer and a thermoplastic polyester resin as the material of the first connection layer, and using a biaxially oriented multilayer co-extrusion system to prepare the core layer having a first connection layer on one side;
step B, applying a thermoplastic resin with function(s) of thermal laminating release, thermal jointing and/or hot stamping to the other side of the core layer as a surface processing layer, then drying, subsequently rolling;
step C, applying an aqueous polyurethane adhesive to the first connection layer as a printed bonding layer, then drying, subsequently rolling;
wherein, step B and step C are not performed in any particular order, that is to say, step B can be performed firstly, and then step C is performed; alternatively, step C can be performed firstly, and then step B is performed.
during step A, the thermoplastic polyester resin is also prepared as the material of the second connection layer, and then the core layer having a first connection layer and a second connection layer on opposite sides, respectively is made by the biaxially oriented multilayer co-extrusion system; and during step B, a layer of thermoplastic resin is applied to the second connection layer as the surface processing layer.

After the production is completed, the surface tension value of the surface processing layer of the card protective film is greater than or equal to 36 dyne, specifically the surface tension value of the surface processing layer of the card protective film is 36 dyne to 38 dyne.

After the production is completed, the surface processing layer of the card protective film has function(s) of thermal laminating release, thermal jointing and/or hot stamping, and the surface processing layer can meet the production process including the technical performance requirements of the magnetic stripe jointing, thermal laminating and/or surface hot stamping, meanwhile it can also meet the production process required by surface personalization including the technical performance requirements of relief/gravure printing, hot coloring, thermal transfer, photo printing, barcode processing, two-dimensional code processing and/or laser engraving.

The present disclosure also provides a payment card comprising a card substrate, the card substrate further comprising a front printed layer and a back printed layer; and each of the front printed layer and the back printed layer of the card substrate is connected to a card protective film of the present disclosure, wherein the printed bonding layer of the card protective film is connected to each of the front printed layer and the back printed layer of the card substrate.

Compared with the related technics, the beneficial effect of the card protective film, the production method and the payment card of the present disclosure lie in that:
1. The card protective film of the present disclosure is a four-layer or five-layer structure, wherein the outer layer is a surface processing layer made by coating with a thermoplastic resin, and has function(s) of thermal laminating release, thermal jointing and/or hot stamping, its surface tension is greater than or equal to 36 dyne, especially the surface tension of the surface processing layer of the card protective film is between 36 dyne (Dyn) and 38 dyne (Dyn), which can meet the surface tension technical performance requirements required by the surface processing of the payment card; and the glass transition temperature of the surface processing layer is close to the softening temperature of polyvinyl chloride, which can also meet the technical performance requirements of temperature required by the surface processing when the card is being laminated.
2. After the card protective film of the present disclosure is adhered to both sides of the payment card, the surface processing layer of the card protective film of the payment card can meet the production process including the technical performance requirements of the magnetic stripe jointing, thermal lamination and/or surface hot stamping, meanwhile it can also meet the production process required by surface personalization including the technical performance requirements of relief/gravure printing, hot coloring, thermal transfer, photo printing, barcode processing, two-dimensional code processing and/or laser engraving.
3. The card protective film of the present disclosure has the advantages of high strength and high temperature resistant grade, and the like, which can provide more protection for the card substrate of the payment card, improve the problems of peeling off and fracture, etc. of the traditional polyvinyl chloride card, and thus increasing the service life of the payment card.
4. The card protective film of the present disclosure has the technical characteristic advantages of high softening temperature and low embrittlement temperature, and the like, which can improve the temperature resistant grade of the payment card to adapt to the use environment with high or low temperature and prevent the protective film of the payment card from peeling off and prevent the card substrate of the payment card from fracture, and thus increasing the service life of the payment card.
5. Based on the technical advantage of high strength possessed by the card protective film of the present disclosure, the strength of the payment card can be improved, and thus the external impact tolerance ability of the payment card can be improved, thereby a protection for the elements such as the chip encapsulated in the payment card from stress impact is provided to prevent the chip of the payment card from being damaged by the external stress impact, and thus increasing the service life of the payment card.

### BRIEF DESCRIPTION OF THE FIGURE

FIG. 1 is a schematic front section view of a card protective film according to Example 1 of the present disclosure;

FIG. 2 is a schematic front section view of a card protective film according to Example 2;

FIG. 3 is a schematic front section view of one example of a payment card made using the card protective film according to Example 2;

FIG. 4 is a schematic front section view of another Example of a payment card made using the card protective film according to Example 2;

FIG. 5 is a schematic main sectional view of one Example of a payment card made using the card protective film according to Example 1;

FIG. 6 is a schematic front section view of another Example of a payment card made using the card protective film according to Example 1;

FIG. 7 is a schematic front section view of a security document made of a security laminate according to the related technics.

### DETAIL DESCRIPTION

The present disclosure will be described in further detail with reference to the accompanying drawings below.

Referring to FIG. 1, a card protective film (10) comprises a core layer 19 of a biaxially oriented polyester film 19, a first connection layer 11 and a printed bonding layer 13 connected to the printed layer of the card substrate, as well as a surface processing layer 12 with function(s) of thermal laminating release, thermal jointing and/or hot stamping; the printed bonding layer 13 is connected to one side of the core layer 19 through the first connection layer 11, and the surface processing layer 12 is connected to the other side of the core layer 19.

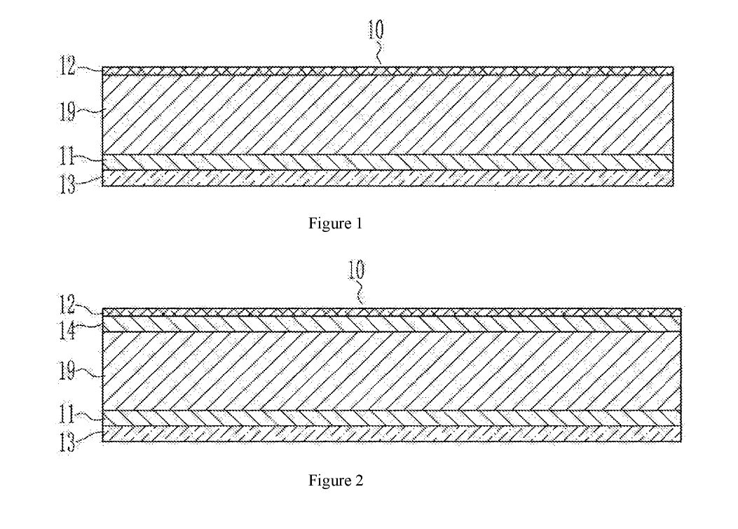

Referring to FIG. 2, in order to make the connection of the surface processing layer 12 more secure, the card protective film 10 further comprises a second connection layer 14 between the core layer 19 and the surface processing layer 12 so that the surface processing layer 12 is connected to the other side of the core layer 19 through the second connection layer 14.

The material of each of the first connection layer 11 and the second connection layer 14 is a thermoplastic polyester resin; and the material of the printed bonding layer 13 is a polyurethane.

Referring to FIG. 1 and FIG. 2, in the above layers, the thickness of the core layer 19 is the largest, and the thickness of the surface processing layer 12 is the smallest.

Referring to FIG. 1 to FIG. 6, the core layer (19) has a thickness between 10 microns and 50 microns, and is a transparent biaxially oriented polyester film (BOPET), which can provide high strength, high temperature resistance, impact resistance and transparency properties, etc., required by the surface protection of the payment card or other cards.

Referring to FIG. 1 to FIG. 6, the first connection layer 11 has a thickness between 3 microns and 5 microns to provide a connection function between the printed bonding layer 13 and the core layer 19. The first connection layer 11 is made with a thermoplastic polyester resin by using a multilayer co-extrusion process in one-step molding together with the biaxially oriented polyester film of the core layer 19.

Referring to FIG. 2 to FIG. 4, the second connection layer 14 has a thickness between 3 microns and 5 microns to provide a connection function between the surface processing layer 12 and the core layer 19. The second connection layer 14 is also made with a thermoplastic polyester resin by using a multilayer co-extrusion process in one-step molding together with the biaxially oriented polyester film of the core layer 19.

Referring to FIG. 1 to FIG. 6, the surface processing layer 12 has a thickness of between 1.0 micron and 2.0 microns and is made by coating with a thermoplastic resin. The surface processing layer 12 has function(s) of thermal laminating release, thermal jointing and/or hot stamping, its surface tension is greater than or equal to 36 dyne, especially the surface tension value of the surface processing layer 12 of the card protective film is between 36 dyne (Dyn) and 38 dyne (Dyn), which can meet the production process including the technical performance requirements of the magnetic stripe jointing, thermal lamination and/or surface hot stamping, meanwhile it can also meet the production process required by surface personalization including the technical performance requirements of relief/gravure printing, hot coloring, thermal transfer, photo printing, barcode processing, two-dimensional code processing and/or laser engraving. The surface processing layer 12 is located outside the payment card or other cards to provide the technical characteristics required by the surface processing of the payment card or other cards when they are being produced.

The material of the surface processing layer 12 is a thermoplastic resin which includes a vinyl chloride-vinyl acetate copolymer (VC/VAC), a modified vinyl chloride-vinyl acetate copolymer (VC/VAC) or an acrylic acid-modified vinyl chloride-vinyl acetate copolymer (VC/VAC), wherein the modified vinyl chloride-vinyl acetate copolymer (VC/VAC) comprises ethylene, vinyl acetate and acrylic acid monomer, and the acrylic acid-modified vinyl chloride-vinyl acetate copolymer (VC/VAC) comprises a vinyl chloride-vinyl acetate copolymer (VC/VAC) and an acrylic resin.

The modified vinyl chloride-vinyl acetate copolymer (VC/VAC) is obtained by copolymerizing ethylene, vinyl acetate and acrylic acid monomer, and their percentages by weight are: 79%-90% of ethylene, 9%-16% of vinyl acetate, and 1%-5% of acrylic acid monomer, that is to say, the modified vinyl chloride-vinyl acetate copolymer (VC/VAC) is obtained by copolymerizing in percentages by weight of 79%-90% of ethylene, 9%-16% of vinyl acetate, and 1%-5% of acrylic acid monomer, and the main production method includes solvent polymerization, emulsion polymerization, suspension polymerization, for example, the modified vinyl chloride-vinyl acetate copolymer (VC/VAC) is obtained by suspension polymerization method. The following specific percentages by weight can be used: 85% of ethylene, 12% of vinyl acetate, and 3% of acrylic acid monomer; alternatively, 89% of ethylene, 10% of vinyl acetate, and 1% of acrylic acid monomer; alternatively, 88% of ethylene, 10% of vinyl acetate, and 2% of acrylic acid monomer; alternatively, 80% of ethylene, 15% of vinyl acetate, and 5% of acrylic acid monomer; alternatively, 83% of ethylene, 13% of vinyl acetate, and 4% of acrylic acid monomer; alternatively, 84% of ethylene, 13% of vinyl acetate, and 3% of acrylic acid monomer, and the like.

The acrylic acid modified vinyl chloride-vinyl acetate copolymer (VC/VAC) is obtained by blending the vinyl chloride-vinyl acetate copolymer (VC/VAC) and the acrylic acid resin, and their percentages by weight are 95%-99% of the vinyl chloride-vinyl acetate copolymer (VC/VAC) and 1%-5% of the acrylic acid resin, that is to say, the acrylic acid modified vinyl chloride-vinyl acetate copolymer (VC/VAC) is obtained by mixing and dissolving in percentages by weight of 95%-99% of the vinyl chloride-vinyl acetate copolymer (VC/VAC) and 1%-5% of the acrylic acid resin. The following specific percentages by weight can be used: 96% of the vinyl chloride-vinyl acetate copolymer (VC/VAC), and 4% of the acrylic acid resin; alternatively, 97% of the vinyl chloride-vinyl acetate copolymer (VC/VAC), and 3% of the acrylic acid resin; alternatively, 98% of the vinyl chloride-vinyl acetate copolymer (VC/VAC), and 2% of the acrylic acid resin, and the like.

Referring to FIG. 1 to FIG. 6, the printed bonding layer (13) has a thickness between 2.5 microns and 5.0 microns and is made by coating with a polyurethane adhesive; the printed bonding layer (13) is bonded to the printed layer of the card substrate of the payment card or other cards during the thermal lamination process for producing the payment card or other cards so as to play the role of protecting the printed layer of the payment card or other cards, and provide bonding strength and protection for the printed layer of the card substrate of the payment card or other cards.

Referring to FIG. 1 and FIG. 2, after the processing and coating of all the layers are completed, the thickness of the finished card protective film 10 is between 20 microns and 60 microns.

Referring to FIG. 1, the present disclosure also provides a method for producing a card protective film, comprising the following steps:
step A, preparing a polyethylene terephthalate as the raw material of the core layer 19 and a thermoplastic polyester resin as the material of the first connection layer 11, and using a biaxially oriented multilayer co-extrusion system to prepare the core layer 19 having a first connection layer 11 on one side;
step B, applying a layer of a thermoplastic resin with function(s) of thermal laminating release, thermal jointing and/or hot stamping to the other side of the core layer 19 as a surface processing layer 12, then drying, subsequently rolling;
step C, applying a layer of an aqueous polyurethane adhesive to the first connection layer 11 as a printed bonding layer 13, then drying, subsequently rolling;
wherein, step B and step C are not performed in any particular order, that is, step B can be performed firstly, and then step C is performed; alternatively, step C can be performed firstly, and then step B is performed.

Referring to FIG. 2, during step A, the thermoplastic polyester resin is also prepared as the material of the second connection layer 14, and then the core layer 19 having a first connection layer 11 and a second connection layer 14 on opposite sides, respectively is made by the biaxially oriented multilayer co-extrusion system; and during step B, a layer of thermoplastic resin is applied to the second connection layer 14 as the surface processing layer 12.

After the production of the card protective film 10 is completed, the surface tension value of the surface processing layer 12 of the card protective film 10 is greater than or equal to 36 dyne, specifically the surface tension value of the surface processing layer 12 of the card protective film is 36 dyne to 38 dyne.

After the production of the card protective film 10 is completed, the surface processing layer 12 of the card protective film has function(s) of thermal laminating release, thermal jointing and/or hot stamping, and the surface processing layer 12 can meet the production process including the technical performance requirements of magnetic stripe jointing, thermal lamination and/or surface hot stamping, meanwhile it can also meet the production process required by the surface personalization including the technical performance requirements of relief/gravure printing, hot coloring, thermal transfer, photo printing, barcode processing, two-dimensional code processing and/or laser engraving.

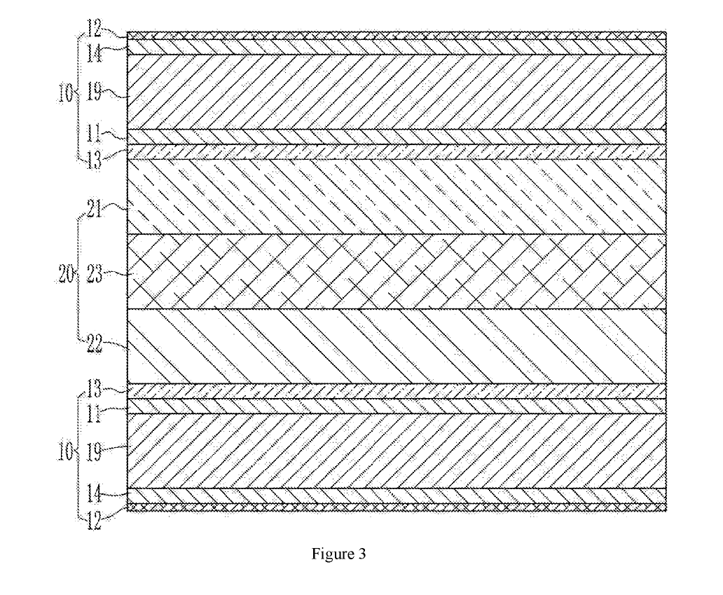

Referring to FIG. 3 to FIG. 6, the present disclosure also provides a payment card comprising a card substrate 20, the card substrate 20 further comprising a front printed layer 21 and a back printed layer 22; and each of the front printed layer 21 and the back printed layer 22 of the card substrate 20 is connected to a card protective film 10 of the present disclosure, wherein the printed bonding layer 13 of the card protective film 10 is connected to each of the front printed layer 21 and the back printed layer 22 of the card substrate 20.

Example 1: Referring to FIG. 2, a five-layer card protective film 10 with a thickness of 50 microns was produced.

Step A, the connection layer and the core layer were made through one-step molding, and polyethylene terephthalate was prepared as the raw material of the core layer 19, and thermoplastic polyester resin was prepared as the material of the first connection layer 11 and the second connection layer 14, wherein the thermoplastic polyester resin was composed of poly(diallyl phthalate) with a percentage by weight of 60%-80% and acetic acid with a percentage by weight of 20%-40%, for example, the thermoplastic polyester resin was composed of poly(diallyl phthalate) with a percentage by weight of 70% and acetic acid with a percentage by weight of 30%. The core layer 19 having a first connection layer 11 and a second connection layer 14 on opposite sides, respectively is made by using the biaxially oriented multilayer co-extrusion system, and the total molding thickness of the core layer 19 and the two connection layers 11 and 14 was controlled at 43 microns. The single-side thickness of each of the connection layer 11 and 14 was controlled in the range of 3 microns to 5 microns.

Step B, a layer of a thermoplastic resin was applied to the second connection layer 14 as a surface processing layer 12. The thermoplastic resin was a modified vinyl chloride-vinyl acetate copolymer (VC/VAC), and ethyl acetate was used as the main solvent. The coating was performed on the McKolo 1750 type high-speed coating equipment and 200 mesh density was selected for the anilox roller for coating. The thickness of the coating was controlled at 1.5 microns to 2.0 microns, and the coating speed was controlled at 80-100 m/min. The modified vinyl chloride-vinyl acetate copolymer (VC/VAC) comprised ethylene, vinyl acetate and acrylic acid monomer, and their percentages by weight are 86.5% of ethylene, 11.5% of vinyl acetate, and 2% of acrylic acid monomer respectively. Drying was performed after coating with an infrared heating type drying system having 5 drying tunnels with the maximum drying temperature of not higher than 180° C.; then rolling after dried.

Step C, a layer of an aqueous polyurethane adhesive was applied to the first connection layer 11 as a printed bonding layer 13, the preparation scheme of the aqueous polyurethane adhesive was as follows: (1) the following component materials were prepared: toluene diisocynate (TDI80/20), dimethylol propylester (DMPA), 1,4-butanediol (BDO), polyether diol (N-220), N-methylpyrrolidone(NMP), acetone, triethylamine and diethylamine, and the component materials were prepared in accordance with a certain proportion; (2) the component materials were mixed and polymerized at 70-80° C. under nitrogen protection; (3) the addition order of each component was as follows: adding toluene diisocyanate and polyether diol in the initial stage; determining the content of -NCO group, when it reached the target value, adding 1, 4-butanediol; after the reaction was maintained for a period of time, reducing the temperature to 70° C., then adding dimethylol propylester to maintain the reaction, after the -NCO group reached the target value, reducing the temperature to 40° C., and then adding triethylamine; during the reaction, adding a certain amount of acetone and N-methylpyrrolidone to control the viscosity; emulsifying with deionized water at room temperature, then adding diethylamine. The aqueous polyurethane adhesive prepared by the above method was applied to the bottom surface of the first connection layer 11 after step B to prepare a printed bonding layer 13. The coating was performed on the McKolo 1750 type coating equipment and 130-150 mesh density was selected for the anilox roller, the thickness of the coating was controlled at 3.0 microns to 5.0 microns, and the coating speed was controlled at 50-70 m/min. Drying was performed after coating with an infrared heating type drying system having 5 drying tunnels with the maximum drying temperature of not higher than 160° C.; then rolling after dried and the rolling temperature was controlled below 25° C.

The card protective film 10 produced via the above steps had a five-layer structure with a thickness of 50 microns; upon measurement, the surface tension value of the surface processing layer 12 was between 36 dyne (Dyn) and 38 dyne (Dyn), which could meet the production process including the technical performance requirements of the magnetic stripe jointing, thermal laminating and/or surface hot stamping, meanwhile it could also meet the production process required by surface personalization including the technical performance requirements of relief/gravure printing, hot coloring, thermal transfer, photo printing, barcode processing, two-dimensional code processing and/or laser engraving.

Example 2: Referring to FIG. 1, a four-layer card protective film 10 with a thickness of 35 microns was produced.

Step A, the connection layer and the core layer were made through one-step molding. Polyethylene terephthalate was prepared as the raw material of the core layer 19, and thermoplastic polyester resin was prepared as the material of the first connection layer 11, wherein the thermoplastic polyester resin was composed of poly(diallyl phthalate) with a percentage by weight of 60%-80% and acetic acid with a percentage by weight of 20%-40%, for example, the thermoplastic polyester resin was composed of poly(diallyl phthalate) with a percentage by weight of 65% and acetic acid with a percentage by weight of 35%. A core layer 19 having a first connection layer 11 on one side is made by using a biaxially oriented multilayer co-extrusion system. The total molding thickness of the core layer 19 and the first connection layer 11 was controlled at 30 microns. The thickness of the first connection layer 11 was controlled in the range of 2 microns to 3 microns.

Step B, a layer of thermoplastic resin was applied to one side of the core layer 19 without connection layer as a surface processing layer 12. The thermoplastic resin was an acrylic acid modified vinyl chloride-vinyl acetate copolymer (VC/VAC), and ethyl acetate was used as the main solvent. The coating was performed on the McKolo 1750 type high-speed coating equipment and 200 mesh density was selected for the anilox roller for coating, the thickness of the coating was controlled at 2.0 microns, and the coating speed was controlled at 80-100 m/min. The acrylic acid modified vinyl chloride-vinyl acetate copolymer (VC/VAC) comprised the vinyl chloride-vinyl acetate copolymer (VC/VAC) and the acrylic acid resin, and the acrylic acid modified vinyl chloride-vinyl acetate copolymer (VC/VAC) was obtained by mixing and dissolving in percentages by weight of 95%-99% of the vinyl chloride-vinyl acetate copolymer (VC/VAC) and 1%-5% of the acrylic acid resin, for example, the acrylic acid modified vinyl chloride-vinyl acetate copolymer (VC/VAC) was obtained by mixing and dissolving in percentages by weight of 98.5% of the vinyl chloride-vinyl acetate copolymer (VC/VAC) with a vinyl acetate content of 13% and 1.5% of the acrylic acid resin. Drying was performed after coating with an infrared heating type drying system having 5 drying tunnels with the maximum drying temperature of not higher than 180° C.; then rolling after dried.

Step C, a layer of an aqueous polyurethane adhesive was applied to the first connection layer 11 as a printed bonding layer 13, the preparation scheme of the aqueous polyurethane adhesive was as follows: (1) the following component materials were prepared: toluene diisocynate (TDI80/20), dimethylol propylester (DMPA), 1,4-butanediol (BDO), polyether diol (N-220), N-methylpyrrolidone(NMP), acetone, triethylamine and diethylamine, and the component materials were prepared in accordance with a certain proportion; (2) the component materials were mixed and polymerized at 70-80° C. under nitrogen protection; (3) the addition order of each component was as follows: adding toluene diisocyanate and polyether diol in the initial stage; determining the content of -NCO group, when it reached the target value, adding 1, 4-butanediol; after the reaction was maintained for a period of time, reducing the temperature to 70° C., adding dimethylol propyl ester, then maintaining the reaction, after the -NCO group reached the target value, reducing the temperature to 40° C., and then adding triethylamine; during the reaction, adding a certain amount of acetone and N-methylpyrrolidone to control the viscosity; emulsifying with deionized water at room temperature, then adding diethylamine. The aqueous polyurethane adhesive prepared by the above method was applied to the bottom surface of the first connection layer 11 after step B to prepare a printed bonding layer 13. The coating was performed on the McKolo 1750 type coating equipment and 130-150 mesh density was selected for the anilox roller for coating, the thickness of the coating was controlled at 3.0 microns to 3.5 microns, and the coating speed was controlled at 50-70 m/min. Drying was performed after coating with an infrared heating type drying system having 5 drying tunnels with the maximum drying temperature of not higher than 160° C.; then rolling after dried, the rolling temperature was controlled below 25° C.

The card protective film (10) produced via the above steps had a four-layer structure with a thickness of 35 microns; upon measurement, the surface tension value of its surface processing layer 12 was between 36 dyne (Dyn) and 38 dyne (Dyn), which could meet the production process including the technical performance requirements of the magnetic stripe jointing, thermal laminating and/or surface hot stamping, meanwhile it could also meet the production process required by the surface personalization including the technical performance requirements of relief/gravure printing, hot coloring, thermal transfer, photo printing, barcode processing, two-dimensional code processing and/or laser engraving.

Application Example 1: Referring to FIG. 3, a payment card was produced by using a five-layer card protective film having a thickness of 50 microns according to the above Example 1 of the present disclosure, which comprised a card substrate 20 which further comprised a front printed layer 21, an intermediate layer 23 and a back printed layer 22, and the card protective film 10 produced according to Example 1; and the payment card was provided with elements such as magnetic stripe, holographic mark, signature bar and chip module, and the like.

Step i, magnetic stripe jointing: A magnetic stripe was bonded to the surface processing layer 12 of a card protective film 10 using a Taiwan Maolong Magnetic Stripe Laminator.

Step ii, material combination: The printed bonding layer 13 of the card protective film 10, the front printed layer 21 of the card substrate 20, the back printed layer 22 of the card substrate 20, and the printed bonding layer (13) of the card protective film 10 bonded with the magnetic stripe as described in step i was combined, a welding device was used to align the position and weld, to make both the front printed layer 21 and the back printed layer 22 of the card substrate 20 were connected to the card protective film 10, wherein the printed bonding layer 13 of the card protective film 10 was connected to each of the front printed layer 21 and the back printed layer 22 of the card substrate 20, and the magnetic stripe was located on the back side of the payment card.

Step iii, thermal lamination: The semi-finished product of step ii was placed in a laminator for thermal lamination, and the laminating parameters were set to a thermal lamination temperature of 150° C., a pressure of 10 MPa and a thermal lamination time of 23 minutes; a cold laminating temperature of 80° C., a pressure of 15 MPa, and a cold laminating time of 23 minutes. A mirror embossing steel plate with a surface roughness of less than or equal to 0.1 was used as the laminated steel plate.

Step iv, Cutting: A large size card produced in step iii was cooled to the room temperature and cut using a Taiwan Maolong card cutter to prepare a single payment card;

Step v, hot stamping processing: The single payment card produced in step iv was subject to the hot stamping processing for holographic mark and signature bar using a Kurz hot stamping machine manufactured in German. The holographic mark was located on the front side of the payment card and the signature bar was located on the back side of the payment card.

Step vi, Module (including chip module) packaging: the payment card produced in the above step v was subject to module packaging by use of a module packaging machine.

The finished payment card produced in the above Application Example 1 conformed to the mirror embossing effect requirement of the payment card in appearance. The printed layers of the card protective film 10 and the card substrate 20 were subjected to a peeling test with the peeling force of more than 6 N/cm, which fully met the provision in ISO7810 Standard of more than 3.5 N/cm; 2000 of the magnetic stripe abrasion tests were performed with a handheld POS machine, and after 2000 card swiping simulation tests, the read and write characteristics of the magnetic stripe remained intact, which could reach the use performance requirements stipulated in ISO7810 standard; the scratch-resistant test of the hot stamping holographic mark was performed with a six blades scraper, and the holographic mark could reach the standard requirement of the payment card; the appearance of the signature bar was inspected visually, which reached the standard requirement of the payment card.

The surface of the finished payment card produced in the Application Example 1 was subject to relief/gravure printing, thermal transfer printing, photo printing, barcode and two-dimensional printing with a NBS payment card personalization device, and the printing results met the quality requirements of the payment card; the finished payment card produced in the Application Example 1 was subject to the cardholder information laser engraving with a laser marking machine from HAN'S LASER, and the quality of the printed information reached the appearance requirement of the payment card.

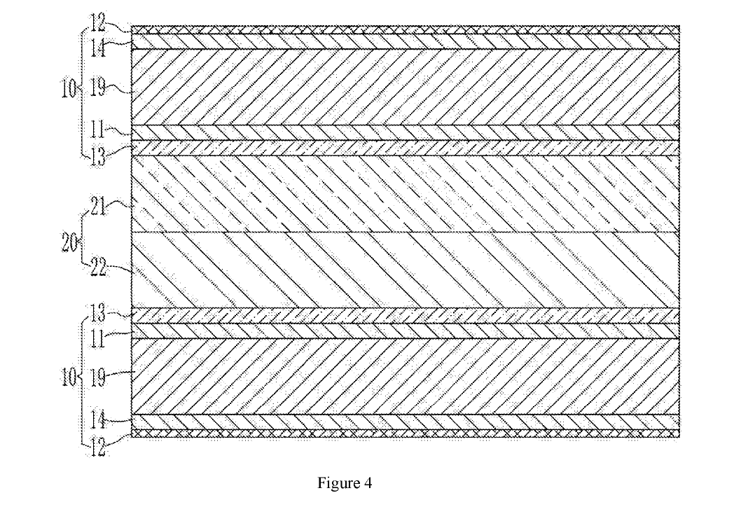

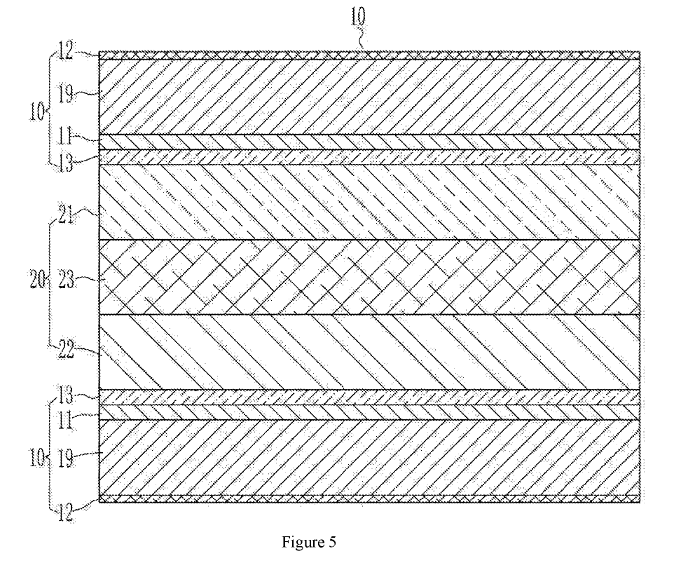

Application Example 2: Referring to FIG. 4, a payment card was produced using a five-layer card protective film having a thickness of 50 microns according to the above Example 1 of the present disclosure, which is substantially the same as that of the Application Example 1, except that: the card substrate 20 of the payment card was slightly different in structure, i.e., the card substrate 20 successively comprised the front printed layer 21 and the back printed layer 22.

Application Example 3: Referring to FIG. 5, a payment card was produced using a four-layer card protective film 10 having a thickness of 35 microns according to the above Example 2 of the present disclosure, which is substantially the same as that of the Application Example 1, except that: (1) the card protective film 10 of the payment card was a four-layer structure, (2) the intermediate layer 23 of the card substrate 20 included an induction antenna and a chip module required by the payment card, and (3) a sub-gloss steel plate with a surface roughness between 0.8 and 1.0 was used as the laminated steel plate in the thermal lamination of step iii. The finished payment card produced in the above Application Example 3 had a matte surface in appearance that met the standard requirement for the matte surface effect in the payment card process.

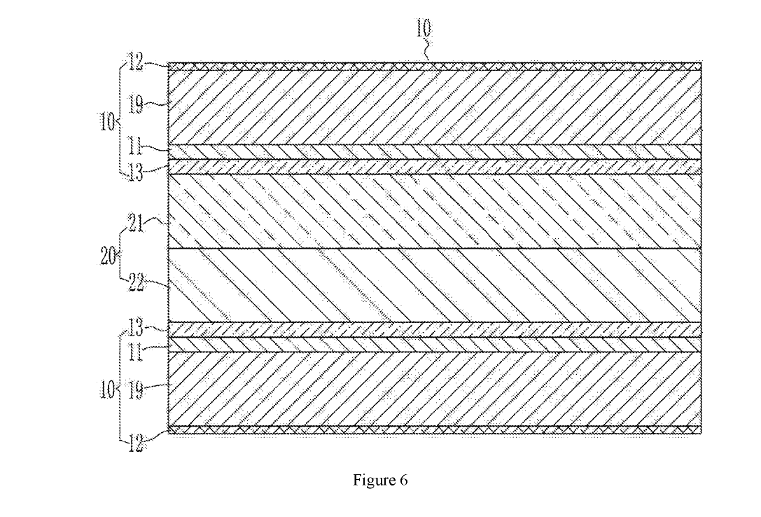

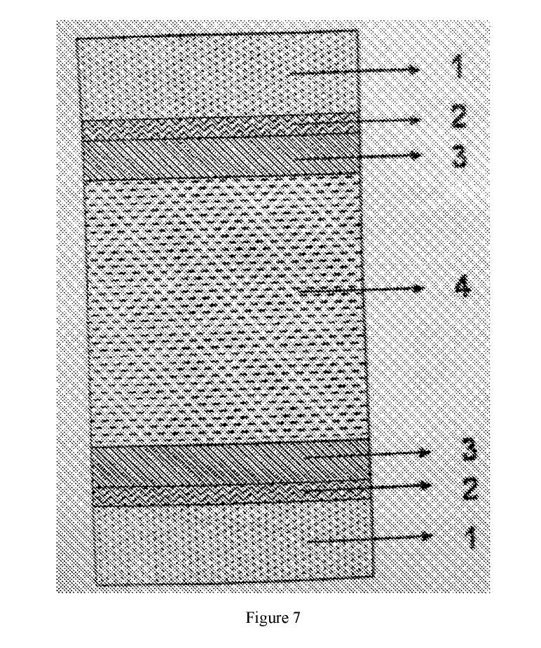

Application Example 4: Referring to FIG. 6, a payment card was produced using a four-layer card protective film having a thickness of 35 microns according to the above Example 2 of the present disclosure, which is substantially the same as that of the Application Example 3, except that: the card substrate 20 of the payment card was slightly different in structure, i.e., the card substrate 20 successively comprised the front printed layer 21 and the back printed layer 22.

The examples described above are merely illustrative of the preferred embodiments of the present disclosure and the descriptions of which are more specific and detailed, however they are not to be construed as limiting the patent scope of the present disclosure; it should be noted that, for those having ordinary skills in the art, several variations and improvements can also be made without departing from the conception of the present disclosure, which all fall within the protection scope of the present disclosure. Therefore, all equivalent alterations and modifications made according to the scope of the claims of the present disclosure are intended to be covered within the scope of the claims of the present disclosure.

1. A card protective film comprising:
a core layer of a biaxially oriented polyester film, a first connection layer and a printed bonding layer connected to a printed layer of a card substrate, as well as a surface processing layer with function(s) of thermal laminating release, thermal jointing and/or hot stamping; the printed bonding layer is connected to one side of the core layer through the first connection layer, and the surface processing layer is connected to the other side of the core layer.

2. The card protective film according to claim 1, wherein:
the material of the surface processing layer is a thermoplastic resin which includes a vinyl chloride-vinyl acetate copolymer, a modified vinyl chloride-vinyl acetate copolymer or an acrylic acid-modified vinyl chloride-vinyl acetate copolymer, wherein the modified vinyl chloride-vinyl acetate copolymer comprises ethylene, vinyl acetate and acrylic acid monomers, and the acrylic acid-modified vinyl chloride-vinyl acetate copolymer comprises a vinyl chloride-vinyl acetate copolymer and an acrylic resin.

3. The card protective film according to claim 2, wherein:
the percentages by weight of the ethylene, vinyl acetate and acrylic monomers are: ethylene of 79%-90%, vinyl acetate of 9%-16%, and acrylic acid monomer of 1%-5%; and the percentages by weight of the vinyl chloride-vinyl acetate copolymer and the acrylic resin are: the vinyl chloride-vinyl acetate copolymer of 95%-99%, and the acrylic resin of 1%-5%.

4. The card protective film according to claim 1, wherein it further comprising a second connection layer disposed between the core layer and the surface processing layer.

5. The card protective film according to claim 4, wherein:
the material of the first connection layer and the second connection layer is a thermoplastic polyester resin; and the material of the printed bonding layer is a polyurethane.

6. The card protective film according to claim 1, wherein:
the card protective film has a thickness of 20.0 microns to 60.0 microns.

7. A method for producing a card protective film, comprising:
preparing a polyethylene terephthalate as the raw material of a core layer and a thermoplastic polyester resin as the material of a first connection layer, and using a biaxially oriented multilayer co-extrusion system to prepare the core layer having the first connection layer on one side;
applying a thermoplastic resin with function(s) of thermal laminating release, thermal jointing or hot stamping to the other side of the core layer as a surface processing layer, then drying, subsequently rolling; and
applying an aqueous polyurethane adhesive to the first connection layer as a printed bonding layer, then drying, subsequently rolling.

8. The method for producing a card protective film according to claim 7, wherein:
the thermoplastic polyester resin is also prepared as the material of a second connection layer, and then the core layer having the first connection layer (11) and the second connection layer on opposite sides, respectively is made by the biaxially oriented multilayer co-extrusion system; and
a layer of the thermoplastic resin is applied to the second connection layer as the surface processing layer.

9. The method for producing a card protective film according to claim 7, wherein:
the surface tension value of the surface processing layer of the card protective film is greater than or equal to 36 dyne, specifically the surface tension value of the surface processing layer of the card protective film is 36 dyne to 38 dyne.

10. The method for producing a card protective film according to claim 7, wherein:
the surface processing layer of the card protective film has function(s) of thermal laminating release, thermal jointing or hot stamping, and the surface processing layer can meet the production process including the technical performance requirements of the magnetic stripe jointing, thermal lamination or surface hot stamping, meanwhile it can also meet the production process required by surface personalization including the technical performance requirements of relief/gravure printing, hot coloring, thermal transfer, photo printing, barcode processing, two-dimensional code processing or laser engraving.

11. A payment card comprising a card substrate which comprises a front printed layer and a back printed layer; wherein:
each of the front printed layer and the back printed layer of the card substrate is connected to a card protective film as defined in claim 1, wherein a printed bonding layer of the card protective film is connected to each of the front printed layer and the back printed layer of the card substrate.
